(19) United States
(12) Patent Application Publication
(10) Pub. No.: US 2023/0106492 A1
(43) Pub. Date: Apr. 6, 2023

(54) SYNTHESIS OF DRAG REDUCING LATEX PRODUCT USING CATIONIC SURFACTANTS IN EMULSION POLYMERIZATION

(71) Applicant: Liquidpower Specialty Products Inc., Houston, TX (US)

(72) Inventor: Rajesh K. MALLAVAJULA, Stillwater, OK (US)

(21) Appl. No.: 17/802,100

(22) PCT Filed: Jan. 28, 2021
(86) PCT No.: PCT/US2021/015474

§ 371 Date: Aug. 24, 2022

Related U.S. Application Data
(60) Provisional application No. 62/983,158, filed on Feb. 28, 2020.

(51) Int. Cl. C09K 8/88; C09K 8/60; F17D 1/17

(52) U.S. Cl. CPC C09K 8/882; C09K 8/604; F17D 1/17; C09K 2208/28

(57) ABSTRACT

A drag reducing composition, methods of forming a drag reducing composition, and methods of using a drag reducing composition to reduce the pressure drop of a liquid hydrocarbon through a conduit are provided. The drag reducing composition includes a latex polymer, a cationic surfactant, optionally a nonionic surfactant, and a continuous phase. The cationic surfactant is selected from quaternary ammonium-based cationic surfactants, imidazolium-based cationic surfactants, pyridinium-based cationic surfactants, or a combination thereof.

### BACKGROUND

### Field

Implementations of the present disclosure generally relate to a drag reducing composition, methods of forming a drag reducing composition, and more particularly, to a drag reducing composition and methods of forming a drag reducing composition including a cationic surfactant.

### Description of the Related Art

A drag reducing composition is one that substantially reduces the friction loss that results from the turbulent flow of a fluid. Where fluids are transported over long distances, such as in oil and other hydrocarbon liquid pipelines, these friction losses result in inefficiencies that increase equipment and operations costs. Ultra-high molecular weight polymers are known to function well as drag reducing composition, particularly in hydrocarbon liquids. In general, drag reduction depends in part upon the molecular weight of the polymer additive and its ability to dissolve in the hydrocarbon under turbulent flow. Effective drag reducing polymers typically have ultra-high molecular weights in excess of five million.

One way to introduce the drag reducing polymers into the flowing hydrocarbon stream is by pumping a drag reducing polymer suspension into the hydrocarbon stream. The ultra-high molecular weight polymers are suspended in a liquid that will not dissolve or will only partially dissolve the ultra-high molecular weight polymer. This suspension is then introduced into the flowing hydrocarbon stream.

However, despite these advances in the field of drag reducing composition, a need still exists for improved drag reducing compositions.

### SUMMARY

The present disclosure generally relates to a drag reducing composition, methods of forming a drag reducing composition, and more particularly, to a drag reducing composition and methods of forming a drag reducing composition including a cationic surfactant.

In one aspect, a drag reducing composition is provided. The drag reducing composition includes a latex polymer, a cationic surfactant, and a continuous phase.

Implementations of the drag reducing composition may include one or more of the following. The latex polymer may include repeating units of the residues of C4-C20 alkyl, C6-C20 substituted or unsubstituted aryl, or aryl-substituted C1-C10 alkyl ester derivatives of methacrylic acid or acrylic acid. The latex polymer may include repeating units of the residues of C4-C20 alkyl, C6-C20 substituted or unsubstituted aryl, or aryl-substituted C1-C10 alkyl ester derivatives of methacrylic acid or acrylic acid. The latex polymer may include repeating units of the residues of 2-ethylhexyl methacrylate. The latex polymer may further include repeating units of the residues of butyl acrylate. The latex polymer may include repeating units of the residues of styrene, 4-tert-butylstyrene, 4-methylstyrene, 3-methylstyrene, 2-methylstyrene, or a combination thereof. The latex polymer may further include repeating units of the residues of 2-ethylhexyl methacrylate. The latex polymer may have a weight average molecular weight of at least about 1 x 10⁶ g/mol. The latex polymer may have a weight average molecular weight of at least about 5 x 10⁶ g/mol. The cationic surfactant can be selected from quaternary ammonium-based cationic surfactants, imidazolium-based cationic surfactants, pyridinium-based cationic surfactants, or a combination thereof. The cationic surfactant may include cetyltrimethylammonium chloride, cetyltrimethylammonium bromide, cetylpyridinium chloride, benzalkonium chloride, benzethonium chloride, dimethyldioctadecylammonium chloride, dioctadecyldimethylammonium bromide, or a combination thereof. The cationic surfactant may include cetyltrimethylammonium chloride. The continuous phase may include water, polar organic liquids, or mixtures thereof.

In another aspect, a method of forming a latex polymer is provided. The method includes polymerizing a reaction mixture via emulsion polymerization, wherein the reaction mixture comprises one or more monomers, a continuous phase, and at least one cationic surfactant.

Implementations of the method of forming may include one or more of the following. The latex polymer may include repeating units of the residues of C4-C20 alkyl, C6-C20 substituted or unsubstituted aryl, or aryl-substituted C1-C10 alkyl ester derivatives of methacrylic acid or acrylic acid. The latex polymer may include repeating units of the residues of C4-C20 alkyl, C6-C20 substituted or unsubstituted aryl, or aryl-substituted C1-C10 alkyl ester derivatives of methacrylic acid or acrylic acid. The latex polymer may include repeating units of the residues of 2-ethylhexyl methacrylate. The latex polymer may further include repeating units of the residues of butyl acrylate. The latex polymer may include repeating units of the residues of styrene, 4-tert-butylstyrene, 4-methylstyrene, 3-methylstyrene, 2-methylstyrene, or a combination thereof. The latex polymer may further include repeating units of the residues of 2-ethylhexyl methacrylate. The latex polymer may have a weight average molecular weight of at least about 1 x 10⁶ g/mol. The latex polymer may have a weight average molecular weight of at least about 5 x 10⁶ g/mol. The cationic surfactant can be selected from quaternary ammonium-based cationic surfactants, imidazolium-based cationic surfactants, pyridinium-based cationic surfactants, or a combination thereof. The cationic surfactant may include cetyltrimethylammonium chloride, cetyltrimethylammonium bromide, cetylpyridinium chloride, benzalkonium chloride, benzethonium chloride, dimethyldioctadecylammonium chloride, dioctadecyldimethylammonium bromide, or a combination thereof. The cationic surfactant may include cetyltrimethylammonium chloride. The continuous phase may include water, polar organic liquids, or mixtures thereof.

The method may further include introducing the drag reducing latex polymer formed according to the method into a pipeline such that a friction loss associated with a turbulent flow through the pipeline is reduced by suppressing growth of turbulent eddies, into a liquid hydrocarbon to thereby produce a treated liquid hydrocarbon wherein the viscosity of the treated liquid hydrocarbon is not less than the viscosity of the liquid hydrocarbon prior to treatment with the drag reducing polymer.

In yet another aspect, a drag reducing composition is provided. The drag reducing composition includes a latex polymer, a cationic surfactant, a nonionic surfactant, and a continuous phase.

Implementations of the drag reducing composition may include one or more of the following. The latex polymer may include repeating units of the residues of C4-C20 alkyl, C6-C20 substituted or unsubstituted aryl, or aryl-substituted C1-C10 alkyl ester derivatives of methacrylic acid or acrylic acid. The latex polymer may include repeating units of the residues of C4-C20 alkyl, C6-C20 substituted or unsubstituted aryl, or aryl-substituted C1-C10 alkyl ester derivatives of methacrylic acid or acrylic acid. The latex polymer may include repeating units of the residues of 2-ethylhexyl methacrylate. The latex polymer may further include repeating units of the residues of butyl acrylate. The latex polymer may include repeating units of the residues of styrene, 4-tert-butylstyrene, 4-methylstyrene, 3-methylstyrene, 2-methylstyrene, or a combination thereof. The latex polymer may further include repeating units of the residues of 2-ethylhexyl methacrylate. The latex polymer may have a weight average molecular weight of at least about 1 x 10⁶ g/mol. The latex polymer may have a weight average molecular weight of at least about 5 x 10⁶ g/mol. The cationic surfactant can be selected from quaternary ammonium-based cationic surfactants, imidazolium-based cationic surfactants, pyridinium-based cationic surfactants, or a combination thereof. The cationic surfactant may include cetyltrimethylammonium chloride, cetyltrimethylammonium bromide, cetylpyridinium chloride, benzalkonium chloride, benzethonium chloride, dimethyldioctadecylammonium chloride, dioctadecyldimethylammonium bromide, or a combination thereof. The cationic surfactant may include cetyltrimethylammonium chloride. The continuous phase may include water, polar organic liquids, or mixtures thereof. The nonionic surfactant may include nonylphenoxy and octylphenoxy poly(ethyleneoxy)ethanols, C8 to C18 ethoxylated primary alcohols, secondary-alcohol ethoxylates, polyoxyethylene sorbitan fatty acid esters, polyethylene oxide (25) oleyl ether, alkylaryl polyether alcohols, or a combination thereof.

In yet another aspect, a method of forming a latex polymer is provided. The method includes polymerizing a reaction mixture via emulsion polymerization, wherein the reaction mixture comprises one or more monomers, a continuous phase, at least one cationic surfactant, and at least one nonionic surfactant.

Implementations of the method of forming may include one or more of the following. The latex polymer may include repeating units of the residues of C4-C20 alkyl, C6-C20 substituted or unsubstituted aryl, or aryl-substituted C1-C10 alkyl ester derivatives of methacrylic acid or acrylic acid. The latex polymer may include repeating units of the residues of C4-C20 alkyl, C6-C20 substituted or unsubstituted aryl, or aryl-substituted C1-C10 alkyl ester derivatives of methacrylic acid or acrylic acid. The latex polymer may include repeating units of the residues of 2-ethylhexyl methacrylate. The latex polymer may further include repeating units of the residues of butyl acrylate. The latex polymer may include repeating units of the residues of styrene, 4-tert-butylstyrene, 4-methylstyrene, 3-methylstyrene, 2-methylstyrene, or a combination thereof. The latex polymer may further include repeating units of the residues of 2-ethylhexyl methacrylate. The latex polymer may have a weight average molecular weight of at least about 1 x 10⁶ g/mol. The latex polymer may have a weight average molecular weight of at least about 5 x 10⁶ g/mol. The cationic surfactant can be selected from quaternary ammonium-based cationic surfactants, imidazolium-based cationic surfactants, pyridinium-based cationic surfactants, or a combination thereof. The cationic surfactant may include cetyltrimethylammonium chloride, cetyltrimethylammonium bromide, cetylpyridinium chloride, benzalkonium chloride, benzethonium chloride, dimethyldioctadecylammonium chloride, dioctadecyldimethylammonium bromide, or a combination thereof. The cationic surfactant may include cetyltrimethylammonium chloride. The continuous phase may include water, polar organic liquids, or mixtures thereof. The nonionic surfactant may include nonylphenoxy and octylphenoxy poly(ethyleneoxy)ethanols, C8 to C18 ethoxylated primary alcohols, secondary-alcohol ethoxylates, polyoxyethylene sorbitan fatty acid esters, polyethylene oxide (25) oleyl ether, alkylaryl polyether alcohols, or a combination thereof.

The method may further include introducing the drag reducing latex polymer formed according to the method into a pipeline such that a friction loss associated with a turbulent flow through the pipeline is reduced by suppressing growth of turbulent eddies, into a liquid hydrocarbon to thereby produce a treated liquid hydrocarbon wherein the viscosity of the treated liquid hydrocarbon is not less than the viscosity of the liquid hydrocarbon prior to treatment with the drag reducing polymer.

### DETAILED DESCRIPTION

In accordance with one aspect of the present disclosure, the pressure drop associated with flowing a liquid hydrocarbon through a conduit, such as a pipeline, can be reduced by treating the liquid hydrocarbon with a drag reducing composition including a latex polymer and a cationic surfactant.

The liquid hydrocarbon may be a light, medium, or heavy crude oil. In one implementation, the liquid hydrocarbon is a heavy crude oil, such as, for example, Merey heavy crude, Petrozuata heavy crude, Corocoro heavy crude, Albian heavy crude, Bow River heavy crude, Maya heavy crude, and San Joaquin Valley heavy crude. Additionally, the liquid hydrocarbon can be a blend of heavy crude oil with lighter hydrocarbons or diluents. Suitable examples of blended crude oils include, but are not limited to, Western Canadian Select and Marlim Blend. In another implementation, the liquid hydrocarbon is a medium crude oil. In yet another implementation, the liquid hydrocarbon is a light crude oil.

In one aspect, the drag reducing composition can be in the form of a latex polymer including a high molecular weight polymer dispersed in an aqueous continuous phase. The latex polymer can be prepared via emulsion polymerization of a reaction mixture including one or more monomers, a continuous phase, at least one cationic surfactant, and an initiation system.

In one aspect, the latex polymer can include a plurality of repeating units of the residues of one or more of the monomers selected from the group consisting of:

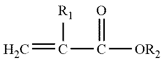

wherein R₁ is H or a C1-C10 alkyl radical, and R₂ is H, a C1-C30 alkyl radical, a C5-C30 substituted or unsubstituted cycloalkyl radical, a C6-C20 substituted or unsubstituted aryl radical, an aryl-substituted C1-C10 alkyl radical, a-(CH2CH2O)x-R_{A} or -(CH2CH(CH3)O)x-R_{A} radical wherein x is in the range of from 1 to 50 and R_{A} is H, a C1-C30 alkyl radical, or a C6-C30 alkylaryl radical;

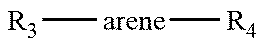

wherein arene is a phenyl, naphthyl, anthracenyl, or phenanthrenyl, R₃ is CH═CH₂ or CH₃—C═CH₂, and R₄ is H, a C1-C30 alkyl radical, a C5-C30 substituted or unsubstituted cycloalkyl radical, C1, SO₃, OR_{B}, or COOR_{C}, wherein R_{B} is H, a C1-C30 alkyl radical, a C5-C30 substituted or unsubstituted cycloalkyl radical, a C6-C20 substituted or unsubstituted aryl radical, or an aryl-substituted C1-C10 alkyl radical, and wherein Rc is H, a C1-C30 alkyl radical, a C5-C30 substituted or unsubstituted cycloalkyl radical, a C6-C20 substituted or unsubstituted aryl radical, or an aryl-substituted C1-C10 alkyl radical;

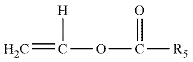

wherein R₅ is H, a C1-C30 alkyl radical, or a C6-C20 substituted or unsubstituted aryl radical;

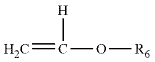

wherein R₆ is H, a C1-C30 alkyl radical, or a C6-C20 substituted or unsubstituted aryl radical;

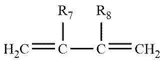

wherein R₇ is H or a C1-C18 alkyl radical, and R8 is H, a C1-C18 alkyl radical, or C1;

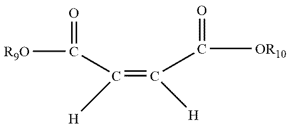

wherein R₉ and R₁₀ are independently H, a C1-C30 alkyl radical, a C6-C20 substituted or unsubstituted aryl radical, a C5-C30 substituted or unsubstituted cycloalkyl radical, or heterocyclic radicals;

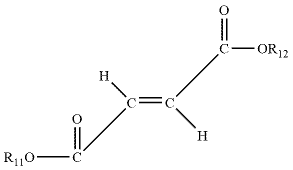

wherein R₁₁ and R₁₂ are independently H, a C1-C30 alkyl radical, a C6-C20 substituted or unsubstituted aryl radical, a C5-C30 substituted or unsubstituted cycloalkyl radical, or heterocyclic radicals;

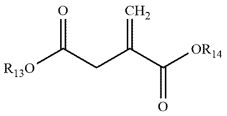

wherein R₁₃ and R₁₄ are independently H, a C1-C30 alkyl radical, a C6-C20 substituted or unsubstituted aryl radical, a C5-C30 substituted or unsubstituted cycloalkyl radical, or heterocyclic radicals;

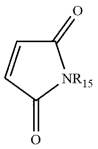

wherein R₁₅ is H, a C1-C30 alkyl radical, a C6-C20 substituted or unsubstituted aryl radical, a C5-C30 substituted or unsubstituted cycloalkyl radical, or heterocyclic radicals;

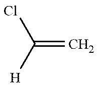

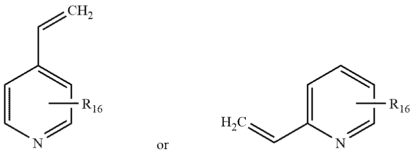

wherein R₁₆ is H, a C1-C30 alkyl radical, or a C6-C20 aryl radical;

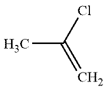

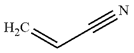

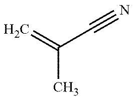

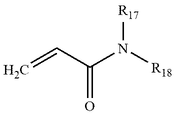

wherein R₁₇ and R₁₈ are independently H, a C1-C30 alkyl radical, a C6-C20 substituted or unsubstituted aryl radical, a C5-C30 substituted or unsubstituted cycloalkyl radical, or heterocyclic radicals;

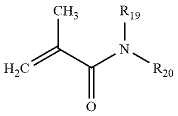

wherein R₁₉ and R₂₀ are independently H, a C1-C30 alkyl radical, a C6-C20 substituted or unsubstituted aryl radical, a C5-C30 substituted or unsubstituted cycloalkyl radical, or heterocyclic radicals.

In one aspect, the latex polymer can include repeating units of the residues of C4-C20 alkyl, C6-C20 substituted or unsubstituted aryl, or aryl-substituted C1-C10 alkyl ester derivatives of methacrylic acid or acrylic acid. In another aspect, the latex polymer can be a copolymer including repeating units of the residues of 2-ethylhexyl methacrylate and the residues of at least one other monomer. In yet another aspect, the latex polymer can be a copolymer including repeating units of the residues of 2-ethylhexyl methacrylate monomers and butyl acrylate monomers. In still another aspect, the latex polymer can be a homopolymer including repeating units of the residues of 2-ethylhexyl methacrylate. In still another aspect, the latex monomer can be a copolymer including repeating units of the residues of styrene, 4-tert-butylstyrene, 4-methylstyrene, 3-methylstyrene, 2-methylstyrene, or a combination thereof and the residues of at least one other monomer. In still another aspect, the latex monomer can be a copolymer including repeating units of the residues of styrene, 4-tert-butylstyrene, 4-methylstyrene, 3-methylstyrene, 2-methylstyrene, or a combination thereof and the residues of 2-ethylhexyl methacrylate.

In one aspect, the latex polymer can include the residues of at least one monomer having a heteroatom. As used herein, the term “heteroatom” includes any atom that is not a carbon or hydrogen atom. Specific examples of heteroatoms include, but are not limited to, oxygen, nitrogen, sulfur, phosphorous, and/or chlorine atoms. In one aspect, the latex polymer can comprise at least about 10 percent, at least about 25 percent, or at least 50 percent of the residues of monomers having at least one heteroatom. Additionally, the heteroatom can have a partial charge. As used herein, the term “partial charge” is defined as an electric charge, either positive or negative, having a value of less than 1.

The continuous phase generally includes at least one component selected from the group consisting of water, polar organic liquids, and mixtures thereof. When water is the selected constituent of the continuous phase, the reaction mixture can also include a buffer. The water can be purified water such as distilled or deionized water. However, the continuous phase can also include polar organic liquids or aqueous solutions of polar organic liquids, such as those listed below. Additionally, as described in more detail below, the continuous phase can optionally include a hydrate inhibitor. In another implementation, the drag reducing polymer can be in the form of a suspension or solution according to any suitable method known in the art.

The reaction mixture for forming the latex polymer further includes at least one cationic surfactant. The cationic surfactant includes a compound having a tail that is hydrophobic and a head that is hydrophilic. The head of the cationic surfactant typically carries a net positive charge. Cationic surfactants useful in compositions of the present disclosure include amino or quaternary hydrophilic moieties, which are positively charged when dissolved in the compositions of the present disclosure. Suitable cationic surfactants can be selected from quaternary ammonium-based cationic surfactants, imidazolium-based cationic surfactants, pyridinium-based cationic surfactants, or a combination thereof.

Examples of suitable cationic surfactants are those corresponding to the formula (I):

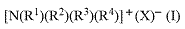

in which R¹, R², R³ and R⁴ are independently selected from (a) an aliphatic group of from 1 to 22 carbon atoms, or (b) an aromatic, alkoxy, polyoxyalkylene, alkylamido, hydroxyalkyl, aryl, or alkylaryl group having up to 22 carbon atoms; and X⁻ is a salt-forming anion such as those selected from halogen, (e.g., chloride, bromide), acetate, citrate, lactate, glycolate, phosphate nitrate, sulfate, and alkylsulfate radicals.

The aliphatic groups can include, in addition to carbon and hydrogen atoms, ether linkages, and other groups, such as amino groups. The longer chain aliphatic groups, for example, those of about 12 carbon atoms, or higher, can be saturated or unsaturated.

In some implementations, the cationic surfactants for compositions of the present disclosure are monoalkyl quaternary ammonium compounds in which the alkyl chain length is C8 to C22, for example, C14 to C18, such as C16.

Suitable examples of such materials correspond to the formula (II):

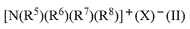

in which R⁵ is a hydrocarbon chain having 8 to 22 carbon atoms, for example, 14 to 18 carbon atoms, such as 16 carbon atoms or a functionalized hydrocarbyl chain having 8 to 22 carbon atoms, for example, 14 to 18 carbon atoms, such as 16 carbon atoms and containing ether, ester, amido, or amino moieties present as substituents or as linkages in the radical chain, and R⁶, R⁷ and R⁸ are independently selected from (a) hydrocarbyl chains of from 1 to 4 carbon atoms, or (b) functionalized hydrocarbyl chains having from 1 to 4 carbon atoms and including one or more aromatic, ether, ester, amido, or amino moieties present as substituents or as linkages in the radical chain, and X⁻ is a salt forming anion such as those selected from halogen, (e.g., chloride, bromide), acetate, citrate, lactate, glycolate, phosphate, nitrate, sulfate, and alkylsulfate radicals.

The functionalized hydrocarbyl chains (b) can include one or more hydrophilic moieties selected from alkoxy (e.g., C1-C3 alkoxy), polyoxyalkylene, alkylester, or combinations thereof.

In some implementations, the hydrocarbon chain R⁵ has 8 to 22 carbon atoms, for example, 14 to 18 carbon atoms, such as 16 carbon atoms. In some implementations, R⁶, R⁷, and R⁸ are independently selected from ethyl and methyl groups. In some implementations, X⁻ is bromide or chloride. The hydrocarbon chains can be derived from source oils which contain substantial amounts of fatty acids having the desired hydrocarbyl chain length.

In one example, R⁵ has 8 to 22 carbon atoms, for example, 14 to 18 carbon atoms, such as 16 carbon atoms, and R⁶, R⁷, and R⁸ are methyl groups.

In another example, R⁵ has 8 to 22 carbon atoms, for example, 14 to 18 carbon atoms, such as 16 carbon atoms, and R⁶, R⁷, and R⁸ are ethyl groups.

Suitable examples include cetyltrimethylammonium chloride (CTAC), cetyltrimethylammonium bromide, and behentrimonium chloride.

In some implementations, the cationic surfactants for compositions of the present disclosure are dialkyl quaternary ammonium compounds in which the alkyl chain length is C8 to C22, for example, C14 to C18, such as C16.

Suitable examples of such materials correspond to the formula (III):

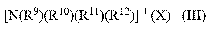

in which R⁹ and R¹⁰ are each independently a hydrocarbon chain having 8 to 22 carbon atoms, for example, 14 to 18 carbon atoms, such as 16 carbon atoms or a functionalized hydrocarbyl chain having 8 to 22 carbon atoms, for example, 14 to 18 carbon atoms, such as 16 carbon atoms and containing ether, ester, amido, or amino moieties present as substituents or a linkages in the radical chain, and R¹¹ and R¹² are independently selected from (a) hydrocarbyl chains of from 1 to 4 carbon atoms, or (b) functionalized hydrocarbyl chains having from 1 to 4 carbon atoms and including one or more aromatic, ether, ester, amido, or amino moieties present as substituents or as linkages in the radical chain, and X⁻ is a salt forming anion such as those selected from halogen, (e.g., chloride, bromide), acetate, citrate, lactate, glycolate, phosphate, nitrate, sulfate, and alkylsulfate radicals.

The functionalized hydrocarbyl chains (b) can include one or more hydrophilic moieties selected from alkoxy (e.g., C1-C3 alkoxy), polyoxyalkylene, alkylester, or combinations thereof.

In some implementations, the hydrocarbon chains R⁹ and R¹⁰ each independently have 8 to 22 carbon atoms, for example, 14 to 18 carbon atoms, such as 16 carbon atoms and R¹¹ and R¹² are independently selected from ethyl and methyl. In some implementations, X⁻ is bromide or chloride.

In one example, R⁹ and R¹⁰ each independently have 8 to 22 carbon atoms, for example, 14 to 18 carbon atoms, such as 16 carbon atoms, R¹¹ and R₁₂ are methyl groups, and X⁻ is bromide or chloride.

In another example, R⁹ and R¹⁰ each independently have 8 to 22 carbon atoms, for example, 14 to 18 carbon atoms, such as 16 carbon atoms, R₁₁ and R¹² are ethyl groups, and X⁻ is bromide or chloride.

In some implementations, the cationic surfactants for compositions of the present disclosure are quaternary benzyl ammonium compounds in which the alkyl chain length is C8 to C22, for example, C14 to C18, such as C16.

Suitable examples of such materials correspond to the formula:

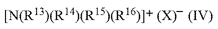

In some implementations, R¹³ is a benzyl group and R¹⁴ is a hydrocarbon chain having the formula CₙH₂ₙ+1, wherein n = 8, 10, 12, 14, 16, or 18, and R¹⁵ and R¹⁶ are independently selected from (a) hydrocarbyl chains of from 1 to 4 carbon atoms, or (b) functionalized hydrocarbyl chains having from 1 to 4 carbon atoms and including one or more aromatic, ether, ester, amido, or amino moieties present as substituents or as linkages in the radical chain, and X⁻ is a salt forming anion such as those selected from halogen, (e.g., chloride, bromide), acetate, citrate, lactate, glycolate, phosphate, nitrate, sulfate, and alkylsulfate radicals.

The (a) hydrocarbyl chains of from 1 to 4 carbon atoms can include one or more methyl groups.

In one example, R¹³ is a benzyl group, R¹⁴ is a hydrocarbon chain having the formula CₙH₂ₙ+1, wherein n = 8, 10, 12, 14, 16, or 18, R¹⁵ and R¹⁶ are methyl groups, and X⁻ is bromide or chloride.

In another example, R¹³ is a benzyl group, R¹⁴ is a hydrocarbon chain having the formula CₙH₂ₙ+1, wherein n = 8, 10, 12, 14, 16, or 18, R¹⁵ and R¹⁶ are ethyl groups, and X⁻ is bromide or chloride.

Suitable examples are benzalkonium chloride and benzethonium chloride.

In some implementations, the cationic surfactants for compositions of the present disclosure are pyridinium-based cationic surfactants, for example, alkylpyridinium salts in which the alkyl chain length is from 10 to 22 carbon atoms (or from 12 to 20 carbon atoms, from 12 to 18 carbon atoms, or from 14 to 16 carbon atoms) and X⁻ represents a halogen atom, for example, chlorine or bromine.

Suitable examples of such materials correspond to the formula (V):

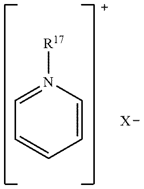

in which R¹⁷ is a hydrocarbon chain having from 10 to 22 carbon atoms (or from 12 to 20 carbon atoms, or from 12 to 18 carbon atoms, or from 14 to 16 carbon atoms) and X- represents a halogen atom, for example, chlorine or bromine.

Suitable examples are cetylpyridinium chloride, cetylpyridinium bromide, lauryl pyridinium chloride, and lauryl pyridinium bromide.

In some implementations, the cationic surfactants for compositions of the present disclosure are imidazolium-based cationic surfactants in which the alkyl chain length is from 10 to 22 carbon atoms (or from 12 to 20 carbon atoms, or from 12 to 18 carbon atoms, or from 14 to 16 carbon atoms) and X- represents a halogen atom such as chlorine or bromine.

Suitable examples of such materials correspond to the formula (VI):

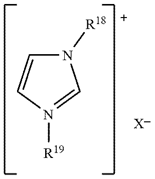

in which R¹⁸ and R₁₉ are each independently selected from a hydrocarbon chain or aromatic having from 1 to 20 carbon atoms (or from 1 to 10 carbon atoms, or from 1 to 4 carbon atoms) and X⁻ represents a halogen atom such as chlorine or bromine.

In some implementations, R¹⁸ is selected from (a) hydrocarbyl chains of from 1 to 4 carbon atoms, for example, 1 to 2 carbon atoms or (b) functionalized hydrocarbyl chains having from 1 to 4 carbon atoms and including one or more aromatic, ether, ester, amido, or amino moieties present as substituents or as linkages in the radical chain and R₁₉ is a hydrocarbon chain having the formula CₙH₂ₙ+1, wherein n = 1, 2, 4, 6, 8, 10, or 12.

In one example, R¹⁹ is an ethyl group, R¹⁸ is a methyl group, and X⁻ is bromide or chloride.

Suitable examples of suitable cationic surfactants include, for example, 1-alkyl-3-alkylimidazolium cationic surfactants, wherein each alkyl group preferably has up to 10, especially up to 8, most preferably up to 4, carbon atoms. Suitable examples include 1-ethyl-3-methylimidazolium chloride, 1-butyl-3-methylimidazolium chloride, 1-ethyl-3-octylimidazolium chloride, 1-hexyl-3-methylimidazolium chloride, 1-decyl-3-methylimidazolium chloride, 1-butyl-3-methylimidazolium chloride, and 1-butyl-3-methylimidazolium chloride.

In one aspect, the cationic surfactant is selected from cetyltrimethylammonium chloride, cetyltrimethylammonium bromide, cetylpyridinium chloride, benzalkonium chloride, benzethonium chloride, dimethyldioctadecylammonium chloride, dioctadecyldimethylammonium bromide, or a combination thereof.

The reaction mixture for forming the latex polymer optionally further includes at least one nonionic surfactant. Exemplary high HLB nonionic surfactants include, but are not limited to, high HLB sorbitan esters, PEG fatty acid esters, ethoxylated glycerine esters, ethoxylated fatty amines, ethoxylated sorbitan esters, block ethylene oxide/propylene oxide surfactants, alcohol/fatty acid esters, ethoxylated alcohols, ethoxylated fatty acids, alkoxylated castor oils, glycerine esters, linear alcohol ethoxylates, and alkyl phenol ethoxylates. Suitable examples of commercially available high HLB nonionic surfactants include, but are not limited to, nonylphenoxy and octylphenoxy poly(ethyleneoxy)ethanols (available as the IGEPAL CA and CO series, respectively from Rhodia, Cranbury, N.J.), C8 to C18 ethoxylated primary alcohols (such as RHODASURF LA-9 from Rhodia Inc., Cranbury, N.J.), C11 to C15 secondary-alcohol ethoxylates (available as the TERGITOL 15-S series, including 15-S-7, 15-S-9, 15-S-12, from Dow Chemical Company, Midland, Mich.), polyoxyethylene sorbitan fatty acid esters (available as the TWEEN series of surfactants from Uniquema, Wilmington, Del.), polyethylene oxide (25) oleyl ether (available as SIPONIC Y-500-70 from Americal Alcolac Chemical Co., Baltimore, Md.), alkylaryl polyether alcohols (available as the TRITON X series, including X-100, X-165, X-305, and X-405, from Dow Chemical Company, Midland, Mich.).

The reaction mixture for forming the latex polymer optionally further includes at least one initiation system. The initiation system for use in the reaction mixture may be any suitable system for generating free radicals to facilitate emulsion polymerization. Possible initiators include, but are not limited to, persulfates (e.g., ammonium persulfate, sodium persulfate, potassium persulfate), peroxy persulfates, and peroxides (e.g., tert-butyl hydroperoxide) used alone or in combination with one or more reducing components and/or accelerators. Possible reducing components include, but are not limited to, bisulfites, metabisulfites, ascorbic acid, erythorbic acid, and sodium formaldehyde sulfoxylate. Possible accelerators include, but are not limited to, any composition containing a transition metal having two oxidation states such as, for example, ferrous sulfate and ferrous ammonium sulfate. Alternatively, known thermal and radiation initiation techniques can be employed to generate the free radicals. Any suitable polymerization and corresponding initiation or catalytic methods known by those skilled in the art may be used in the present disclosure. For example, when polymerization is performed by methods such as addition or condensation polymerization, the polymerization can be initiated or catalyzed by methods such as cationic, anionic, or coordination methods.

The reaction mixture for forming the latex polymer optionally further includes a buffer. The buffer can include any known buffer that is compatible with the initiation system such as, for example, carbonate, phosphate, and/or borate buffers.

The reaction mixture for forming the latex polymer optionally further includes at least one hydrate inhibitor. The hydrate inhibitor can be a thermodynamic hydrate inhibitor such as, for example, an alcohol and/or a polyol. In one example, the hydrate inhibitor includes one or more polyhydric alcohols and/or one or more ethers of polyhydric alcohols. Suitable polyhydric alcohols include, but are not limited to, monoethylene glycol, diethylene glycol, triethylene glycol, monopropylene glycol, and/or dipropylene glycol. Suitable ethers of polyhydric alcohols include, but are not limited to, ethylene glycol monomethyl ether, diethylene glycol monomethyl ether, propylene glycol monomethyl ether, and dipropylene glycol monomethyl ether.

Generally, the hydrate inhibitor can be any suitable composition that when mixed with distilled water at a 1:1 weight ratio produces a hydrate inhibited liquid mixture having a gas hydrate formation temperature at 2,000 psia that is lower than the gas hydrate formation temperature of distilled water at 2,000 psia by an amount in the range of from about 10 to about 150° F., for example, about -12 to about 65° C., in the range of from about 20 to about 80° F., for example, about -6.6 to about 26.6° C., or in the range of from 30 to 60° F., for example, about -1.1 to about 15.6° C. For example, monoethylene glycol qualifies as a hydrate inhibitor because the gas hydrate formation temperature of distilled water at 2,000 psia is about 70° F., for example, about 21° C., while the gas hydrate formation temperature of a 1:1 mixture of distilled water and monoethylene glycol at 2,000 psia is about 28° F., for example, about 5.5° C. Thus, monoethylene glycol lowers the gas hydrate formation temperature of distilled water at 2,000 psia by about 42° F., for example, about 5.5° C., when added to the distilled water at a 1:1 weight ratio. It should be noted that the gas hydrate formation temperature of a particular liquid may vary depending on the compositional make-up of the natural gas used to determine the gas hydrate formation temperature. Therefore, when gas hydrate formation temperature is used herein to define what constitutes a “hydrate inhibitor,” such gas hydrate temperature is presumed to be determined using a natural gas composition containing 92 mole percent methane, 5 mole percent ethane, and 3 mole percent propane.

In one example, the reaction mixture is formed by combining the monomer, water, the at least one cationic surfactant, optionally at least one nonionic surfactant, and optionally the hydrate inhibitor, under a substantially oxygen-free atmosphere that is maintained at less than about 1,000 ppmw oxygen or less than about 100 ppmw oxygen. The oxygen-free atmosphere can be maintained by continuously purging the reaction vessel with an inert gas such as nitrogen and/or argon. The temperature of the system can be kept at a level from the freezing point of the continuous phase up to about 60° C., in the range of from about 0 to about 45° C., or in the range of from about 0 to about 30° C. The system pressure can be maintained in the range of from about 5 to about 100 psia, in the range of from about 10 to about 25 psia, or about atmospheric pressure. However, higher pressures up to about 300 psia can be necessary to polymerize certain monomers, such as diolefins.

Next, an optional buffer can be added, followed by addition of the initiation system, either all at once or over time. The polymerization reaction is carried out for a sufficient amount of time to achieve at least about 90 percent conversion by weight of the monomers. Typically, this time period is in the range of from between about 1 to about 10 hours, or in the range of from 3 to 5 hours. During polymerization, the reaction mixture can be continuously agitated.

The following Table I sets forth approximate broad and narrow ranges for the amounts of the ingredients present in the reaction mixture.

TABLE I

| Ingredient | Broad Range | Narrow Range |
|---|---|---|
| Monomer (wt. % of reaction mixture) | 10 - 60% | 30 - 50% |
| Water (wt. % of reaction mixture) | 20 - 80% | 50 - 70% |
| Cationic Surfactant (wt. % of reaction mixture) | 0.1 - 10% | 0.25 - 6% |
| Initiation system | | |
| Monomer: Initiator (molar ratio) | 1x10³:1 - 5x10⁶:1 | 5x1 0³:1 - 2x1 0⁶: 1 |
| Monomer: Reducing Comp. (molar ratio) | 1 x10³:1 - 5x10⁶:1 | 1x10⁴:1 - 2x10⁶:1 |
| Accelerator: Initiator (molar ratio) | 0.001:1-10:1 | 0.005:1-1:1 |
| Buffer | 0 to amount necessary to reach pH of initiation (initiator dependent, typically a pH between about 6.5-10) | |
| Optional hydrate inhibitor | If present, the hydrate inhibitor can have a hydrate inhibitor-to-water weight ratio from about 1:10 to about 10:1, about 1:5 to about 5:1, or 2:3 to 3:2. | |

The emulsion polymerization reaction yields a latex composition including a dispersed phase of solid latex polymer particles and a liquid continuous phase. The latex composition can be a stable colloidal dispersion including a dispersed phase of high molecular weight polymer particles and a continuous phase including water. The latex composition can include colloidal particles in the range of from about 10 to about 60 percent by weight of the latex composition, or in the range of from 40 to 50 percent by weight of the latex composition. The continuous phase can include water, the cationic surfactant, the hydrate inhibitor (if present), and the buffer as needed. Water can be present in the range of from about 20 to about 80 percent by weight of the latex composition, or in the range of from about 40 to about 60 percent by weight of the latex composition. The cationic surfactant can comprise in the range of from about 0.1 to about 10 percent by weight of the latex composition, or in the range of from 0.25 to 6 percent by weight of the latex composition. As noted in Table I, the buffer can be present in an amount necessary to reach the pH required for initiation of the polymerization reaction and is initiator dependent. Typically, the pH required to initiate a reaction is in the range of from 6.5 to 10.

When a hydrate inhibitor is employed in the reaction mixture, it can be present in the resulting latex composition in an amount that yields a hydrate inhibitor-to-water weight ratio in the range of from about 1:10 to about 10:1, in the range of from about 1:5 to about 5:1, or in the range of from 2:3 to 3:2. Alternatively, all or part of the hydrate inhibitor can be added to the latex composition after polymerization to provide the desired amount of hydrate inhibitor in the continuous phase of the latex composition.

In one aspect, the latex polymer of the dispersed phase of the latex composition can have a weight average molecular weight (Mw) of at least about 1 x 10⁶ g/mol, at least about 2 x 10⁶ g/mol, or at least 5 x 10⁶ g/mol. The colloidal particles of the latex polymer can have a mean particle size of less than about 10 microns, less than about 1,000 nm (1 micron), in the range of from about 10 to about 500 nm, or in the range of from 50 to 250 nm. At least about 95 percent by weight of the colloidal particles can be larger than about 10 nm and smaller than about 500 nm. At least about 95 percent by weight of the particles can be larger than about 25 nm and smaller than about 250 nm. The continuous phase can have a pH in the range of from about 4 to about 10, or in the range of from about 6 to about 8, and contains few if any multivalent cations.

In one aspect, the latex polymer includes at least about 10,000, at least about 25,000, or at least 50,000 repeating units selected from the residues of the above mentioned monomers. In one aspect, the latex polymer includes less than one branched unit per each monomer residue-repeating unit. Additionally, the latex polymer includes less than one linking group per each monomer residue-repeating unit. Furthermore, the latex polymer can exhibit little or no branching or crosslinking. In addition, the latex polymer can include perfluoroalkyl groups in an amount in the range of from about 0 to about 1 percent based on the total number of monomer residue repeating units in the drag reducing polymer.

As mentioned above, a liquid hydrocarbon can be treated with the latex polymer in order to reduce drag associated with flowing the liquid hydrocarbon through a conduit. In order for the latex polymer to function as a drag reducer, the latex polymer should dissolve or be substantially solvated in the liquid hydrocarbon. Accordingly, the latex polymer can have a solubility parameter that is within about 20 percent, about 18 percent, about 15 percent, or 10 percent of the solubility parameter of the liquid hydrocarbon, as discussed above.

The solubility parameter of the latex polymer is determined according to the Van Krevelen method of the Hansen solubility parameters. This method of determining solubility parameters can be found on pages 677 and 683-686 of Brandrup et al., Polymer Handbook (4th ed., vol. 2, Wiley-Interscience, 1999), which is incorporated herein by reference. According to Brandrup et al., the following general equation was developed by Hansen and Skaarup to account for dispersive forces, polar interactions, permanent dipole-dipole interactions, and hydrogen bonding forces in determining solubility parameters:

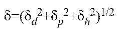

where δ is the solubility parameter, δ_{d} is the term adjusting for dispersive forces, δₚ is the term adjusting for polar interactions, and δₕ is the term adjusting for hydrogen bonding and permanent dipole-induced dipole. Systems have been developed to estimate the above terms using a group contribution method, measuring the contribution to the overall solubility parameter by the various groups including the polymer. The following equations are used in determining the solubility parameter of a polymer according to the Van Krevelen method:

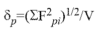

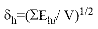

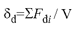

The above equations and an explanation of how they are used can be found on pages 677 and 683-686 of Brandrup et al. The values for the variables F and E in the above equations are given in table 4, page 686 of Brandrup et al., based on the different residues comprising a polymer. For example, a methyl group (-CH₃) is given the following values: F_{d}i, = 420 (J^{½}cm³^{/2}/mol), Fₚi = 0 (J^{½}cm³^{/2}/mol), Eₕᵢ= 0 J/mol. Additionally, the values for the variable V in the above equations are given in Table 3 on page 685 of Brandrup et al. where, for example, a methyl group (-CH₃) is given a value of V = 33.5 (cm³/mol). Using these values, the solubility parameter of a polymer can be calculated.

The latex polymer can have a solubility parameter, as determined according to the above equations, of at least about 17 MPa^{½}, in the range of from about 17.1 to about 24 MPa^{½}, or in the range of from 17.5 to 23 MPa^{½}. Furthermore, the latex polymer can have a solubility parameter that is within about 4 MPa^{½}, within about 3 MPa^{½}, or within 2.5 MPa^{½} of the solubility parameter of the liquid hydrocarbon.

The drag reducing composition including the latex polymer can be added to the liquid hydrocarbon in an amount sufficient to yield a latex polymer concentration in the range of from about 0.1 to about 500 ppmw, in the range of from about 0.5 to about 200 ppmw, in the range of from about 1 to about 100 ppmw, or in the range of from 2 to 50 ppmw. In one example, at least about 50 weight percent, at least about 75 weight percent, or at least 95 weight percent of the solid latex polymer particles can be dissolved by the liquid hydrocarbon. In one example, the viscosity of the liquid hydrocarbon treated with the latex polymer is not less than the viscosity of the liquid hydrocarbon prior to treatment with the drag reducing polymer.

The efficacy of the high molecular weight polymer particles as drag reducers when added directly to a liquid hydrocarbon is largely dependent upon the temperature of the liquid hydrocarbon. Thus, in one example, the liquid hydrocarbon can have a temperature at the time of treatment with the latex polymer of at least about 30° C., or at least 40° C.

The drag reducing composition employed in the present disclosure can provide significant percent drag reduction. For example, the drag reducing composition can provide at least about 5 percent drag reduction, at least about 15 percent drag reduction, or at least 20 percent drag reduction.

### EXAMPLES

The following non-limiting examples are provided to further illustrate implementations described herein. However, the examples are not intended to be all inclusive and are not intended to limit the scope of the implementations described herein. The particular materials and amounts thereof, as well as other conditions and details recited in these examples should not be used to limit the aspects described herein.

### Example 1: Preparation of Latex Drag Reducer Using 2-Ethyl Hexyl Methacrylate

A drag-reducing latex was prepared by polymerizing 2-ethylhexyl methacrylate in an emulsion including water, cationic surfactant, nonionic surfactant, initiator, and a buffer. The polymerization was performed in a 1000 mL jacketed reaction kettle with a condenser, mechanical stirrer, thermocouple, septum ports, and nitrogen inlets/outlets. The kettle was charged with 320 grams of 2-ethylhexyl methacrylate (monomer), 113.6 grams of ethylene glycol, 170.3 grams of distilled water, 30.08 grams of AMMONYXO CETAC-30 (cationic surfactant, available from Stepan Company of Northfield, III.), 32.0 grams of TERGITOL ™ 15-S-7 (surfactant, available from Dow Chemical Company of Midland, Mich.), 10.4 grams of pH buffer solution (8.7 grams of potassium phosphate monobasic, 6.8 grams of potassium phosphate dibasic in 100 grams of water) and 16 grams of a solution of ammonium persulfate (0.133 grams of ammonium persulfate dissolved in 40 grams of distilled water). The mixture was agitated using a blade type stirrer at 400 rpm to emulsify the monomer in the water, glycol, and surfactant carrier. The mixture was then purged with nitrogen to remove any traces of oxygen in the reactor and cooled to about 41° F., for example, about 5° C. The polymerization reaction was initiated by adding into the reactor 20.0 mL of a solution of ferrous ammonium sulfate hexahydrate (0.1725 grams ferrous ammonium sulfate hexahydrate dissolved in 200 grams of 0.01 M sulfuric acid solution) at a rate of 1.25 mL per hour using a syringe pump via small-bore tubing. The polymerization reaction was carried out with agitation for about 16 hours.

### Example 2: Preparation of Latex Drag Reducer With a Mixture of 2-Ethylhexyl Methacrylate and N-Butyl Acrylate

A drag-reducing latex was prepared by polymerizing 2-ethylhexyl methacrylate and n-butyl acrylate in an emulsion including water, cationic surfactant, nonionic surfactant, initiator, and a buffer. The polymerization was performed in a 1000 mLjacketed reaction kettle with a condenser, mechanical stirrer, thermocouple, septum ports, and nitrogen inlets/outlets. The kettle was charged with 256 grams of 2-ethylhexyl methacrylate (monomer), 64 grams of n-butyl acrylate, 113.6 grams of ethylene glycol, 170.3 grams of distilled water, 30.08 grams of AMMONYXO CETAC-30 (cationic surfactant, available from Stepan Company of Northfield, III.), 32.0 grams of TERGITOL ™ 15-S-7 (surfactant, available from Dow Chemical Company of Midland, Mich.), 10.4 grams of pH buffer solution (8.7 grams of potassium phosphate monobasic, 6.8 grams of potassium phosphate dibasic in 100 grams of water) and 16 grams of a solution of ammonium persulfate (0.133 grams of ammonium persulfate dissolved in 40 grams of distilled water). The mixture was agitated using a blade type stirrer at 400 rpm to emulsify the monomer in the water, glycol, and surfactant carrier. The mixture was then purged with nitrogen to remove any traces of oxygen in the reactor and cooled to about 41° F., for example, about 5° C. The polymerization reaction was initiated by adding into the reactor 20.0 mL of a solution of ferrous ammonium sulfate hexahydrate (0.1725 grams ferrous ammonium sulfate hexahydrate dissolved in 200 grams of 0.01 M sulfuric acid solution) at a rate of 1.25 mL per hour using a syringe pump via small-bore tubing. The polymerization reaction was carried out with agitation for about 16 hours.

### Example 3: Preparation of Latex Drag Reducer With a Mixture of 2-Ethylhexyl Methacrylate and Styrene

A drag-reducing latex was prepared by polymerizing 2-ethylhexyl methacrylate and styrene in an emulsion including water, cationic surfactant, nonionic surfactant, initiator, and a buffer. The polymerization was performed in a 1000 mL jacketed reaction kettle with a condenser, mechanical stirrer, thermocouple, septum ports, and nitrogen inlets/outlets. The kettle was charged with 256 grams of 2-ethylhexyl methacrylate (monomer), 64 grams of styrene, 113.6 grams of ethylene glycol, 170.3 grams of distilled water, 30.08 grams of AMMONYXO CETAC-30 (cationic surfactant, available from Stepan Company of Northfield, III.), 32.0 grams of TERGITOL ™ 15-S-7 (surfactant, available from Dow Chemical Company of Midland, Mich.), 10.4 grams of pH buffer solution (8.7 grams of potassium phosphate monobasic, 6.8 grams of potassium phosphate dibasic in 100 grams of water) and 16 grams of a solution of ammonium persulfate (0.133 grams of ammonium persulfate dissolved in 40 grams of distilled water). The mixture was agitated using a blade type stirrer at 400 rpm to emulsify the monomer in the water, glycol, and surfactant carrier. The mixture was then purged with nitrogen to remove any traces of oxygen in the reactor and cooled to about 41° F., for example, about 5° C. The polymerization reaction was initiated by adding into the reactor 20.0 mL of a solution of ferrous ammonium sulfate hexahydrate (0.1725 grams ferrous ammonium sulfate hexahydrate dissolved in 200 grams of 0.01 M sulfuric acid solution) at a rate of 1.25 mL per hour using a syringe pump via small-bore tubing. The polymerization reaction was carried out with agitation for about 16 hours.

### Drag Reduction Measurements of Latex Drag Reducers

Flow loop testing was performed to evaluate the effectiveness of the latex composition of the present disclosure as a drag reducer. Percent drag reduction (% DR) was measured in a 100-ft long, 1-inch nominal pipe (0.957-inch inner diameter) containing diesel fuel flowing at 9.97 gallons per minute. Prior to testing, the latex composition was added to a mixture of 3 parts kerosene to 2 parts isopropyl alcohol by mass and slowly dissolved under low shear conditions to make a polymeric solution containing 0.43 to 0.45% polymer by mass. The solution was injected at a rate of 16.8 mL/min into the diesel fuel in the flow loop, which corresponded to 1.8 to 2.0 ppm by mass concentration in the diesel fuel. The volumetric flow rate of the diesel fuel was held constant during the test, and frictional pressure drop was measured over the 100-foot pipe with no drag reducer present and with drag reducer present. Percent drag reduction was calculated from the pressure measurements as follows:

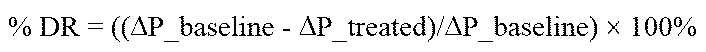

where ΔP_baseline represents the frictional pressure drop with no drag reducer treatment and ΔP treated represents the frictional pressure drop with drag reducer treatment.

The drag reduction composition for Examples 1-3 was tested by the above-described method and the results are depicted in Table II.

TABLE II

| Example | Percent drag reduction (% DR) |
|---|---|
| 1 | 26% |
| 2 | 21% |
| 3 | 28% |

The composition from Example 1 was tested and resulted in 26% DR. The composition from Example 2 was tested in the same manner and resulted in 21% DR. The composition from Example 3 was tested in the same manner and resulted in 28% DR.

Each of the documents referred to above is incorporated herein by reference. The mention of any document is not an admission that such document qualifies as prior art or constitutes the general knowledge of the skilled person in any jurisdiction. Except where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the disclosure can be used together with ranges or amounts for any of the other elements.

When introducing elements of the present disclosure or exemplary aspects or implementation(s) thereof, the articles “a,” “an,” “the” and “said” are intended to mean that there are one or more of the elements.

The transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative implementations, the phrases “consisting essentially of” and “consisting of,” where “consisting of” excludes any element or step not specified and “consisting essentially of” permits the inclusion of additional unrecited elements or steps that do not materially affect the essential or basic and novel characteristics of the composition or method under consideration.

While the foregoing is directed to implementations of the present invention, other and further implementations of the invention may be devised without departing from the basic scope thereof, and the scope thereof is determined by the claims that follow.

1. A drag reducing composition, comprising:
a latex polymer;
a cationic surfactant; and
a continuous phase.

2. The composition of claim 1, wherein the cationic surfactant is selected from quaternary ammonium-based cationic surfactants, imidazolium-based cationic surfactants, pyridinium-based cationic surfactants, or a combination thereof.

3. The composition of claim 1, wherein the latex polymer comprises repeating units of the residues of one or more monomers selected from the group consisting of: 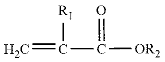
wherein R₁ is H or a C1-C10 alkyl radical, and R₂ is H, a C1-C30 alkyl radical, a C5-C30 substituted or unsubstituted cycloalkyl radical, a C6-C20 substituted or unsubstituted aryl radical, an aryl-substituted C1-C10 alkyl radical, a -(CH2CH2O)x-R_{A} or -(CH2CH(CH3)O)x-R_{A} radical wherein x is in the range of from 1 to 50 and R_{A} is H, a C1-C30 alkyl radical, or a C6-C30 alkylaryl radical; 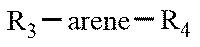
wherein arene is a phenyl, naphthyl, anthracenyl, or phenanthrenyl, R₃ is CH═CH₂ or CH₃—C═CH₂, and R₄ is H, a C1-C30 alkyl radical, a C5-C30 substituted or unsubstituted cycloalkyl radical, C1, SO₃, OR_{B}, or COOR_{C}, wherein R_{B} is H, a C1-C30 alkyl radical, a C5-C30 substituted or unsubstituted cycloalkyl radical, a C6-C20 substituted or unsubstituted aryl radical, or an aryl-substituted C1-C10 alkyl radical, and wherein R_{C} is H, a C1-C30 alkyl radical, a C5-C30 substituted or unsubstituted cycloalkyl radical, a C6-C20 substituted or unsubstituted aryl radical, or an aryl-substituted C1-C10 alkyl radical; 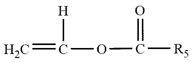
wherein R₅ is H, a C1-C30 alkyl radical, or a C6-C20 substituted or unsubstituted aryl radical; 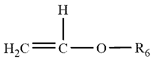
wherein R₆ is H, a C1-C30 alkyl radical, or a C6-C20 substituted or unsubstituted aryl radical; 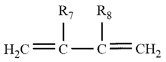
wherein R₇ is H or a C1-C18 alkyl radical, and R8 is H, a C1-C18 alkyl radical, or C1; 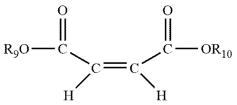
wherein R₉ and R₁₀ are independently H, a C1-C30 alkyl radical, a C6-C20 substituted or unsubstituted aryl radical, a C5-C30 substituted or unsubstituted cycloalkyl radical, or heterocyclic radicals; 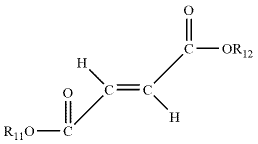
wherein R₁₁ and R₁₂ are independently H, a C1-C30 alkyl radical, a C6-C20 substituted or unsubstituted aryl radical, a C5-C30 substituted or unsubstituted cycloalkyl radical, or heterocyclic radicals; 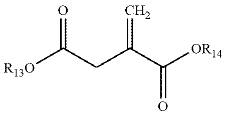
wherein R₁₃ and R₁₄ are independently H, a C1-C30 alkyl radical, a C6-C20 substituted or unsubstituted aryl radical, a C5-C30 substituted or unsubstituted cycloalkyl radical, or heterocyclic radicals; 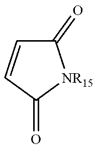
wherein R₁₅ is H, a C1-C30 alkyl radical, a C6-C20 substituted or unsubstituted aryl radical, a C5-C30 substituted or unsubstituted cycloalkyl radical, or heterocyclic radicals; 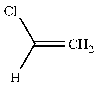 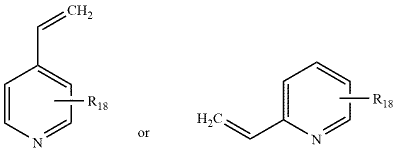
wherein R₁₆ is H, a C1-C30 alkyl radical, or a C6-C20 aryl radical; 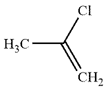 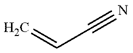 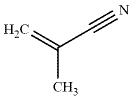 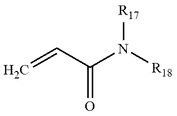
wherein R₁₇ and R₁₈ are independently H, a C1-C30 alkyl radical, a C6-C20 substituted or unsubstituted aryl radical, a C5-C30 substituted or unsubstituted cycloalkyl radical, or heterocyclic radicals; and 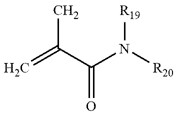
wherein R₁₉ and R₂₀ are independently H, a C1-C30 alkyl radical, a C6-C20 substituted or unsubstituted aryl radical, a C5-C30 substituted or unsubstituted cycloalkyl radical, or heterocyclic radicals.

4. The composition of claim 1, wherein the latex polymer comprises repeating units of the residues of C4-C20 alkyl, C6-C20 substituted or unsubstituted aryl, or aryl-substituted C1 -C10 alkyl ester derivatives of methacrylic acid or acrylic acid.

5. The composition of claim 1, wherein the latex polymer comprises repeating units of the residues of 2-ethylhexyl methacrylate.

6. The composition of claim 5, wherein the latex polymer further comprises repeating units of the residues of butyl acrylate.

7. The composition of claim 1, wherein the latex polymer comprises repeating units of the residues of styrene, 4-tert-butylstyrene, 4-methylstyrene, 3-methylstyrene, 2-methylstyrene, or a combination thereof.

8. The composition of claim 7, wherein the latex polymer further comprises repeating units of the residues of 2-ethylhexyl methacrylate.

9. The composition of claim 1, wherein the latex polymer has a weight average molecular weight of at least about 1 x 10⁶ g/mol.

10. (canceled)

11. The composition of claim 1, wherein the cationic surfactant comprises cetyltrimethylammonium chloride, cetyltrimethylammonium bromide, cetylpyridinium chloride, benzalkonium chloride, benzethonium chloride, dimethyldioctadecylammonium chloride, dioctadecyldimethylammonium bromide, or a combination thereof.

12. The composition of claim 11, wherein the cationic surfactant is cetyltrimethylammonium chloride.

13. The composition of claim 1, wherein the continuous phase comprises water, polar organic liquids, or mixtures thereof.

14. The composition of claim 1, further comprising a nonionic surfactant.

15. The composition of claim 14, wherein the nonionic surfactant comprises nonylphenoxy and octylphenoxy poly(ethyleneoxy)ethanols, C8 to C18 ethoxylated primary alcohols, secondary-alcohol ethoxylates, polyoxyethylene sorbitan fatty acid esters, polyethylene oxide (25) oleyl ether, alkylaryl polyether alcohols, or a combination thereof.

16. A method for forming a drag reducing latex polymer, comprising:
polymerizing a reaction mixture via emulsion polymerization, wherein the reaction mixture comprises one or more monomers, a continuous phase, and at least one cationic surfactant.

17. The method of claim 16, wherein the cationic surfactant is selected from quaternary ammonium-based cationic surfactants, imidazolium-based cationic surfactants, pyridinium-based cationic surfactants, or a combination thereof.

18. The method of claim 16, wherein the one or more monomers are selected from the group consisting of: 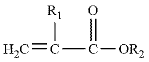
wherein R₁ is H or a C1-C10 alkyl radical, and R₂ is H, a C1-C30 alkyl radical, a C5-C30 substituted or unsubstituted cycloalkyl radical, a C6-C20 substituted or unsubstituted aryl radical, an aryl-substituted C1-C10 alkyl radical, a -(CH2CH2O)x-R_{A} or -(CH2CH(CH3)O)x-R_{A} radical wherein x is in the range of from 1 to 50 and R_{A} is H, a C1-C30 alkyl radical, or a C6-C30 alkylaryl radical; 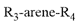
wherein arene is a phenyl, naphthyl, anthracenyl, or phenanthrenyl, R₃ is CH═CH₂ or CH₃—C═CH₂, and R₄ is H, a C1-C30 alkyl radical, a C5-C30 substituted or unsubstituted cycloalkyl radical, C1, SO₃, OR_{B}, or COOR_{C}, wherein R_{B} is H, a C1-C30 alkyl radical, a C5-C30 substituted or unsubstituted cycloalkyl radical, a C6-C20 substituted or unsubstituted aryl radical, or an aryl-substituted C1-C10 alkyl radical, and wherein R_{C} is H, a C1-C30 alkyl radical, a C5-C30 substituted or unsubstituted cycloalkyl radical, a C6-C20 substituted or unsubstituted aryl radical, or an aryl-substituted C1-C10 alkyl radical; 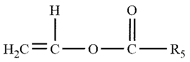
wherein R₅ is H, a C1-C30 alkyl radical, or a C6-C20 substituted or unsubstituted aryl radical; 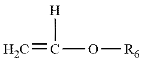
wherein R₆ is H, a C1-C30 alkyl radical, or a C6-C20 substituted or unsubstituted aryl radical; 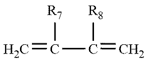
wherein R₇ is H or a C1-C18 alkyl radical, and R8 is H, a C1-C18 alkyl radical, or C1; 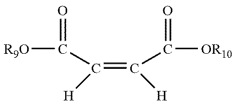
wherein R₉ and R₁₀ are independently H, a C1-C30 alkyl radical, a C6-C20 substituted or unsubstituted aryl radical, a C5-C30 substituted or unsubstituted cycloalkyl radical, or heterocyclic radicals; 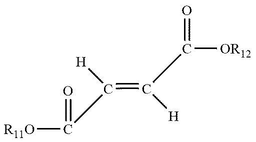
wherein R₁₁ and R₁₂ are independently H, a C1-C30 alkyl radical, a C6-C20 substituted or unsubstituted aryl radical, a C5-C30 substituted or unsubstituted cycloalkyl radical, or heterocyclic radicals; 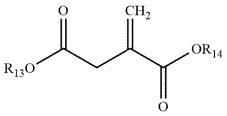
wherein R₁₃ and R₁₄ are independently H, a C1-C30 alkyl radical, a C6-C20 substituted or unsubstituted aryl radical, a C5-C30 substituted or unsubstituted cycloalkyl radical, or heterocyclic radicals; 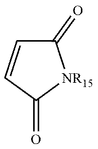
wherein R₁₅ is H, a C1-C30 alkyl radical, a C6-C20 substituted or unsubstituted aryl radical, a C5-C30 substituted or unsubstituted cycloalkyl radical, or heterocyclic radicals; 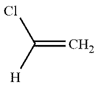 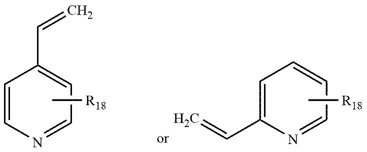
wherein R₁₆ is H, a C1-C30 alkyl radical, or a C6-C20 aryl radical; 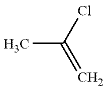 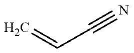 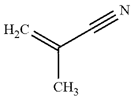 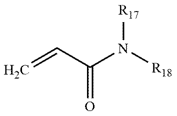
wherein R₁₇ and R₁₈ are independently H, a C1-C30 alkyl radical, a C6-C20 substituted or unsubstituted aryl radical, a C5-C30 substituted or unsubstituted cycloalkyl radical, or heterocyclic radicals; and 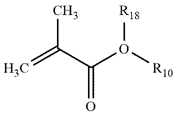
wherein R₁₉ and R₂₀ are independently H, a C1-C30 alkyl radical, a C6-C20 substituted or unsubstituted aryl radical, a C5-C30 substituted or unsubstituted cycloalkyl radical, or heterocyclic radicals.

19. The method of claim 16, wherein the one or more monomers comprise C4-C20 alkyl, C6-C20 substituted or unsubstituted aryl, or aryl-substituted C1-C10 alkyl ester derivatives of methacrylic acid or acrylic acid.

20. The method of claim 16, wherein the one or more monomers comprise 2-ethylhexyl methacrylate.

21. (canceled)

22. The method of claim 16, wherein the latex polymer comprises repeating units of the residues of styrene, 4-tert-butylstyrene, 4-methylstyrene, 3-methylstyrene, 2-methylstyrene, or a combination thereof.

23. (canceled)

24. (canceled)

25. (canceled)

26. The method of claim 16, wherein the cationic surfactant comprises cetyltrimethylammonium chloride, cetyltrimethylammonium bromide, cetylpyridinium chloride, benzalkonium chloride, benzethonium chloride, dimethyldioctadecylammonium chloride, or dioctadecyldimethylammonium bromide.

27. (canceled)

28. The method of claim 26, wherein the continuous phase comprises water, polar organic liquids, or mixtures thereof.

29. The method of claim 16, wherein the reaction mixture further comprises at least one nonionic surfactant selected from the group consisting of nonylphenoxy and octylphenoxy poly(ethyleneoxy)ethanols, C8 to C18 ethoxylated primary alcohols, secondary-alcohol ethoxylates, polyoxyethylene sorbitan fatty acid esters, polyethylene oxide (25) oleyl ether, alkylaryl polyether alcohols, or a combination thereof.

30. (canceled)

31. A method, comprising:
introducing the drag reducing latex polymer formed according to the method of any of claims 16 to 30 into a pipeline such that a friction loss associated with a turbulent flow through the pipeline is reduced by suppressing growth of turbulent eddies, into a liquid hydrocarbon to thereby produce a treated liquid hydrocarbon wherein the viscosity of the treated liquid hydrocarbon is not less than the viscosity of the liquid hydrocarbon prior to treatment with the drag reducing polymer.
